(19) United States
(12) Patent Application Publication
(10) Pub. No.: US 2022/0138366 A1
(43) Pub. Date: May 5, 2022

(54) SMART INFRASTRUCTURE

(71) Applicant: Hyperloop Technologies, Inc., Los Angeles, CA (US)

(72) Inventors: Mohammed Ismaeel BABUR, Los Angeles, CA (US); Dihan YANG, Alhambra, CA (US); Min-Tak CHEUNG, Gardena, CA (US); Naveen D'souza LAZAR, Pasadena, CA (US)

(73) Assignee: Hyperloop Technologies, Inc., Los Angeles, CA (US)

(21) Appl. No.: 17/513,726

(22) Filed: Oct. 28, 2021

Related U.S. Application Data
(60) Provisional application No. 63/107,249, filed on Oct. 29, 2020.

(51) Int. Cl. G06F 30/13; G06Q 10/06

(52) U.S. Cl. CPC G06F 30/13; G06F 2111/18; G06Q 10/067; G06Q 10/06313

(57) ABSTRACT

A system for design and implementation of a project that includes a plurality of design and testing tools directed to phases of the project's lifecycle. The plurality of design and testing tools is usable for physical horizontal and vertical infrastructure and the physical and vertical infrastructure of the project is constructed based upon a project design created and tested from the plurality of design and testing tools.

### CROSS-REFERENCE TO RELATED APPLICATION

This application is a Nonprovisional U.S. patent application claiming the benefit of U.S. Provisional Application No. 63/107,249 filed Oct. 29, 2020, the disclosure of which is expressly incorporated by reference herein in its entirety.

### BACKGROUND

### 1. Field of the Disclosure

The present disclosure relates to a user interface for design of infrastructure lifecycle.

### 2. Background of the Disclosure

In a typical infrastructure project's lifecycle, off-the-shelf design software for CAD and GIS activities are used to prepare early feasibility designs with a low level of detail. Assumptions are made throughout the early design process about existing and future constraints as well as operations and maintenance requirements. A rough order of magnitude cost estimate and schedule is produced and provided to the project sponsor, owner, stakeholder, or public agency. As the project matures through the design, delivery, construction, commissioning, and operations and maintenance phases of the project lifecycle, the cost and schedule estimated in the early feasibility stage of the project is well exceeded. A major root cause to such cost overruns is that poor design decisions were made early on, and the associated cost and schedule estimates did not adequately quantify uncertainty and risks.

It is possible to make better design decisions much earlier on in the lifecycle at very early stages of the project. The tools described in this disclosure enable well-informed early decisions to be made by automating strenuous and tedious design tasks, digitalizing multiple dimensions of data via integration with complex 3D design models, determining optimal designs by using complex mathematical algorithms and approaches to complex multi-dimensional geometries, and simulating operational and temporal data in complex 3D environments. Some of these tools improve upon existing off-the-shelf design software capabilities by integrating with API's, while others are developed from scratch. The current infrastructure industry does not use such an approach in early or even late stages of the project lifecycle. There is no incentive to engineering consultants or contractors in early stages of a project to use such an approach or methodology, as their contractual obligations are limited to their scope, and the amount of effort required to develop such capabilities is infeasible for them. Various delivery structures with project sponsors or owners further exacerbate the issue, as contractors and consultants will each be under separate contractual obligations with the owner, but not with each other. This leads to a lack of a cohesive incentive, which leads to cost and schedule overruns. However, this can also be mitigated by use of the tools in this disclosure by empowering the owner with the necessary level of detail and information very early on from the inception of the infrastructure project, allowing the owner to adequately quantify risk and uncertainty and develop contractual obligations that are in their best interest.

### SUMMARY

This application describes embodiments of a computational approach to project lifecycle, which includes automation, digitalization, optimization, and simulation tools that enable rapid design activities targeting various phases of a project's lifecycle. The tools can be used for any type of physical horizontal or vertical infrastructure, including but not limited to roads, rail, pipelines, powerlines, stations, airports, facilities, utilities, hyperloop, etc.

The novel features which are characteristic of the disclosure, both as to structure and method of operation thereof, together with further aims and advantages thereof, will be understood from the following description, considered in connection with the accompanying drawings, in which the preferred embodiment of the disclosure is illustrated by way of example. It is to be expressly understood, however, that the drawings are for the purpose of illustration and description only, and they are not intended as a definition of the limits of the disclosure.

Aspects of the present disclosure are directed to a novel system for designing the lifecycle of infrastructure projects. The system utilizes various tools, including automation, digitalization, optimization and simulation tools, which allow for the acceleration of decisions and processes earlier in the project lifecycle and for avoidance of capital cost and schedule overruns. The tools can be software tools and can run iterative processes for fine tuning to achieve optimum results.

Embodiments are directed to a system for design and implementation of a project that includes a plurality of design and testing tools directed to phases of the project's lifecycle, in which the plurality of design and testing tools are usable for physical horizontal and vertical infrastructure. The physical and vertical infrastructure of the project is constructed based upon a project design created and tested from the plurality of design and testing tools.

In embodiments, the project may include at least one of roads, rails, pipelines, powerlines, stations, airports, facilities, utilities, or a hyperloop.

According to embodiments, the plurality of design and testing tools can include automation tools for monitoring and analyzing topological surface elevations on land and under water for at least one of potential locations for construction of the project, or for determining a length of a curve for vehicles to accelerate through a turn at a switch without passengers experiencing excessive lateral or rotational forces. The automation tool can include a network topology creator tool that creates an entire network geometry connecting multiple origins and destinations, and can includes switch geometries for point-to-point travel between each of the multiple origins and the destinations. The automation tool may include a 3D portal creator to design and produce a passenger portal for passengers of a vehicle to embark and disembark the vehicle and for storage and maintenance of the vehicles.

In accordance with embodiments, the plurality of design and testing tools can include digitalization tools for creating representations of planned or existing conditions. The digitalization tools may incorporate a building information modeling (BIM) framework with at least one of schedule integration, cost integration, portal sustainability and digital twin tools. The BIM framework can be integrated with augmented or virtual reality (AR/VR) tools to show modeled construction, commissioning, operations or maintenance activities at a particular site. Moreover, at least one of: for construction, the AR/VR tools can be operable to project to a user a chronological construction from the ground up of the project over a view of the site where the user is located, or for commissioning and operations, the AR/VR tools can be operable to show animations of a maneuvering of a vehicle in at least one degree of freedom or moving or actuating of structural elements. The digitalization tool further includes at least one of a schedule integration tool that incorporate temporal data into the BIM framework to determine construction sequencing of the project, a cost integration tool for determining quantity takeoff, estimating, budgeting, forecasting and cash flow, or a portal sustainability tool to check the infrastructure of compliance with certification criteria to be environmentally friendly and energy and resource efficient.

In other embodiments, the plurality of design and testing tools can include optimization tools for finding solutions to minimize or maximize various objectives, subject to constraints. The optimization tools may include a profile optimizer that iteratively examines different courses for the infrastructure over the geographic profile to find a best course. The different courses can be designed for passenger comfort, angle of traverse, vehicle capabilities, vehicle speed and vehicle energy requirements. Further, the optimization tool may include a 3D optimizer that is an iterative process over multiple geospatial datasets, such as but not limited to terrain, land use, environmentally sensitive areas, parcel cost, etc. to minimize various objectives such as but not limited to capital costs, travel times, energy consumption, environmental impact or maximize various objectives such as but not limited to passenger comfort, energy efficiency, etc. of the project based on various courses over multiple geospatial data layers where the project is to be constructed.

According to still other embodiments, the plurality of design and testing tools can include simulation tools for creating at least one of representations of run-time operations of vehicles over a guideway of the project or step-wise construction of the project. The simulation tools may include at least one of dynamic clash detection, construction sequence simulation, or passenger and portal operations simulation. The dynamic clash detection can be at least one of operable to simulate a clash between models used in the project design or to simulate operation of a vehicle traveling over a guideway of the project. The construction sequence simulation may be operable to show a building of the project from ground up. Further, the simulation tools can include simulations for quantifying cost risk and uncertainty at every level of the project.

Embodiments are directed to a smart infrastructure system for design and implementation of a project that includes a processor; and at least one memory containing instructions that, when executed by the processor, cause the processor to perform operations including: at least one of monitoring and analyzing topological surface elevations on land and under water for at least one of potential locations for construction of the project, or for determining a length of a curve for vehicles to accelerate through a turn at a switch without passengers experiencing excessive lateral or rotational forces; using AR/VR tools to at least one of project to a user a chronological construction from the ground up of the project over a view of the site where the user is located, or show animations of a maneuvering of a vehicle in at least one degree of freedom or moving or actuating of structural elements; at least one of determining construction sequencing of the project, determining quantity takeoff and estimating, budgeting, forecasting and cash flow, or checking the infrastructure of compliance with certification criteria to be environmentally friendly and energy and resource efficient; and simulating at least one of a clash between models used in the project design or operation of a vehicle traveling over a guideway of the project.

### BRIEF DESCRIPTION OF THE DRAWINGS

These and other features of this disclosure will be best understood by reference to the following detailed description of a preferred embodiment of the disclosure, taken in conjunction with the accompanying drawings, in which:

FIG. 1 shows an exemplary graphic for a project lifecycle;

FIG. 2 shows an exemplary capital cost allocation versus spending graph;

FIG. 3 shows a design cost versus capital costs graph;

FIG. 4 shows an exemplary elevation query;

FIG. 5 shows an exemplary graph of effects on a vehicle in a high speed switch;

FIGS. 6-10 show exemplary screenshots of the network topology creator tool;

FIG. 11 shows an exemplary layout from a 3D portal creator;

FIG. 12 shows an exemplary screen shot from the 3D portal creator;

FIG. 13 shows an exemplary portal created by the 3D portal creator;

FIG. 14 shows an exemplary 3D BIM model;

FIGS. 15-17 show exemplary views of the construction using an augmented reality/virtual reality application on a tablet;

FIG. 18 shows an exemplary screen shot of a schedule integration tool;

FIG. 19 shows an exemplary cost integration with a federated model;

FIGS. 20 and 21 show comparative examples of the infrastructure using a digital twin tool;

FIG. 22 shows an exemplary embodiment of a linear infrastructure cost function;

FIG. 23 shows an exemplary initial course for infrastructure over an existing ground profile;

FIGS. 24-29 show exemplary alternative courses to the initial course in FIG. 23 over the existing ground profile reducing capital cost;

FIG. 30 show a comparison of exemplary of alternative courses 302-308 over the existing ground profile;

FIG. 31 shows an exemplary histogram of the optimized profile of the infrastructure course versus the real-world course shown in FIG. 30;

FIG. 32-36 show the iterative processes analyzing capital costs over various paths traversing the terrain;

FIG. 37 shows market values of various parcels of land on a map of an area of interest for linear infrastructure optimization;

FIG. 38 shows an optimized least cost path of a course for a linear infrastructure project;

FIG. 39 shows a view of an exemplary simulation for dynamic clash detection for a vehicle passing through a gate valve in a near-vacuum environment;

FIG. 40 shows a view of an exemplary simulation for clash detection for a vehicle through a tight turn radius in a near-vacuum environment;

FIGS. 41-52 show views of an exemplary simulation of the construction process;

FIG. 53 shows exemplary simulations performed to quantify cost risk and uncertainty at various levels of infrastructure;

FIGS. 54-56 show views of exemplary passenger and portal operations simulations; and

FIG. 57 shows an exemplary environment for practicing aspects of the present disclosure.

### DETAILED DESCRIPTION

The detailed description illustrates by way of example, not by way of limitation, the principles of the disclosure. This description will clearly enable one skilled in the art to make and use the disclosure, and describes several embodiments, adaptations, variations, alternatives and uses of the disclosure, including what is presently believed to be the best mode of carrying out the disclosure. It should be understood that the drawings are diagrammatic and schematic representations of exemplary embodiments of the disclosure, and are not limiting of the present disclosure nor are they necessarily drawn to scale.

Embodiments of the present disclosure may be used in a transportation system, for example, as described in commonly-assigned application Ser. No. 15/007,783, titled “Transportation System,” the contents of which are hereby expressly incorporated by reference herein in their entirety.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly, “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A” may also (essentially) consist of the compound A.

The various embodiments disclosed herein can be used separately and in various combinations unless specifically stated to the contrary.

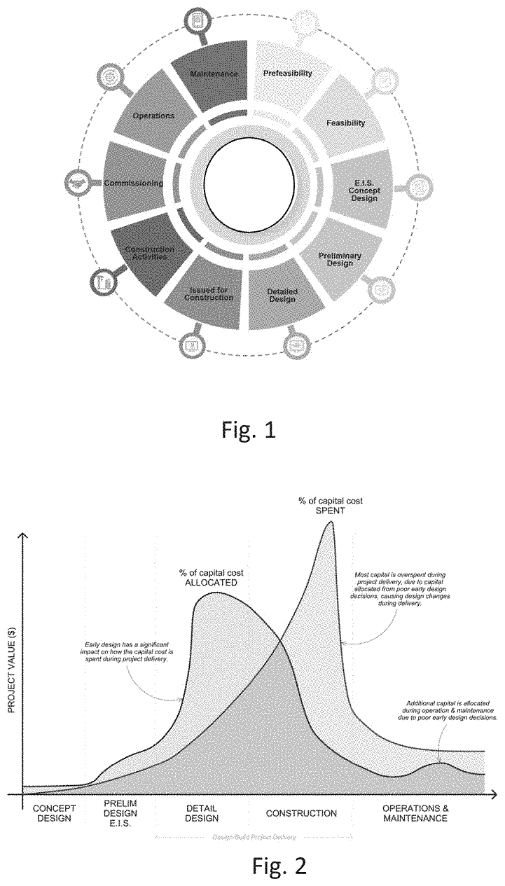

The typical lifecycle of an infrastructure project, e.g., a transportation project, has a number of steps or stages. This project lifecycle 1 includes four main stages, i.e., project development 2, project delivery 6, commissioning 11 and operation & management (O&M) 13. Referring to FIG. 1, the project development stage 2 can include prefeasibility studies 3, feasibility studies 4 and environmental impact statement (EIS) concept design 5; the project delivery stage 6 can include preliminary designs 7, detailed designs 8, issuing the design for construction 9 and construction activities 10; the commissioning stage includes commissioning the project and handing it over to the operator 12; and the O&M stage 13 includes post construction operating activities 14 and maintenance activities 15, which continue until the project is decommissioned.

FIG. 2 graphically illustrates a cost curve 20 for percent of capital cost allocation of the project lifecycle versus a spending curve 25 for percent of capital cost spent during the project lifecycle. Cost curve 20 shows that early design has a significant impact on how the capital cost is spent during the project delivery stage, i.e., when the design requires changing at this stage, and that additional capital may also be allocated during the O&M stage, which is generally the result of poor early-stage design decisions. Spending curve 25 shows that most capital is overspent during project delivery, due to capital allocated from poor early design decisions causing design changes during delivery.

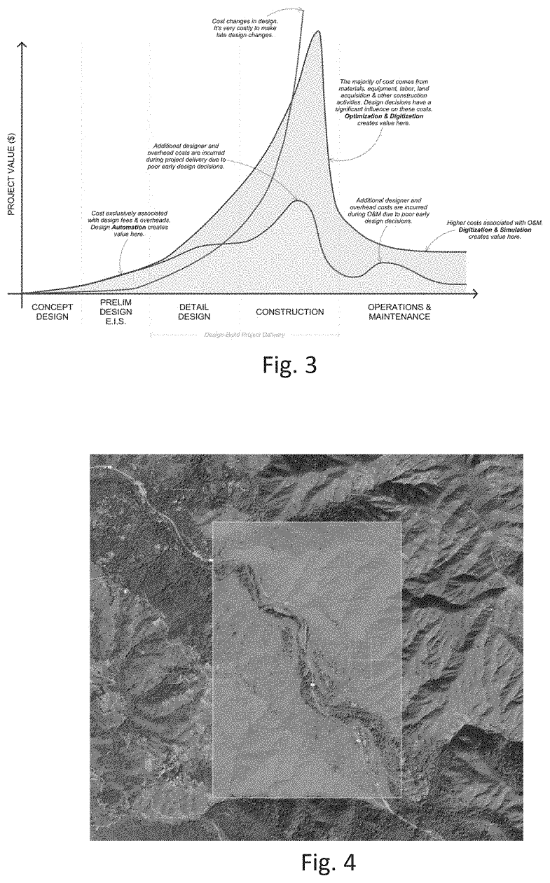

FIG. 3 graphically illustrates a design cost curve 30 for the project lifecycle versus a capital costs curve 35 for the project lifecycle. Design cost curve 30 shows that early on in the project, e.g., up to and through preliminary design and EIS in project development, costs are almost exclusively associated with design fees and overheads, but as the project progresses, design costs increase, particularly when additional designer and overhead costs are incurred during project construction as a result of poor early design decisions made during project delivery. Further design costs can be incurred during O&M for additional designer and overhead costs required to remedy poor early design decisions. Capital curve 35 shows that most capital is spent during construction, the majority of which comes from materials, equipment, labor, land acquisition, and other construction activities. Design decisions have a significant influence on these costs. FIG. 3 also shows a cost curve 38 that show the cost for design changes during the project lifecycle, where early on in the project, design costs are low, but as the project moves into the construction stage, costs associated with design changes can exceed the capital budget for the project.

To address these unforeseen and extremely high capital cost expenditures due to poor early design decisions in the above cost curves of FIGS. 2 and 3, the inventors have devised a computational approach to infrastructure lifecycle to accelerate decisions and processes earlier in the lifecycle of infrastructure projects. This computational approach includes the stages of: Automation, Digitalization, Optimization, and Simulation.

The Automation stage is utilized for automating standardized or tedious workflows and parameterizing or sweeping the design space. The automation stage utilizes a number of unique tools, which include elevation query, high-speed switch (HSS) & low-speed switch (LSS) solver and sweeper, network topology creator and parametric 3D portal creator. These tools, which can be software, hardware, firmware and combinations thereof, have been developed to facilitate the automation stage of the infrastructure lifecycle.

The elevation query tool can be used to identify the various topographical elevations in the areas under consideration for the infrastructure. The elevation query tool can query map elevation data, e.g., the GOOGLE MAPS elevation application programming interface (API) or other map elevation APIs to create triangulated surfaces. In this way, elevations can be obtained for any area (on land) in the world. The tool can also create bathymetric triangulated surfaces for terrain below large water bodies, such as oceans, by querying APIs with bathymetric data. As shown in FIG. 4, the elevation query tool can designate an area of interest using polygons for larger areas and/or curvilinear corridor centerlines for more precisely identified areas of interest. By way of example, an area on the map on which the infrastructure is intended for construction can be queried with the elevation tool to determine the various elevations in the terrain for providing guidance in determining a best location and/or path for the infrastructure.

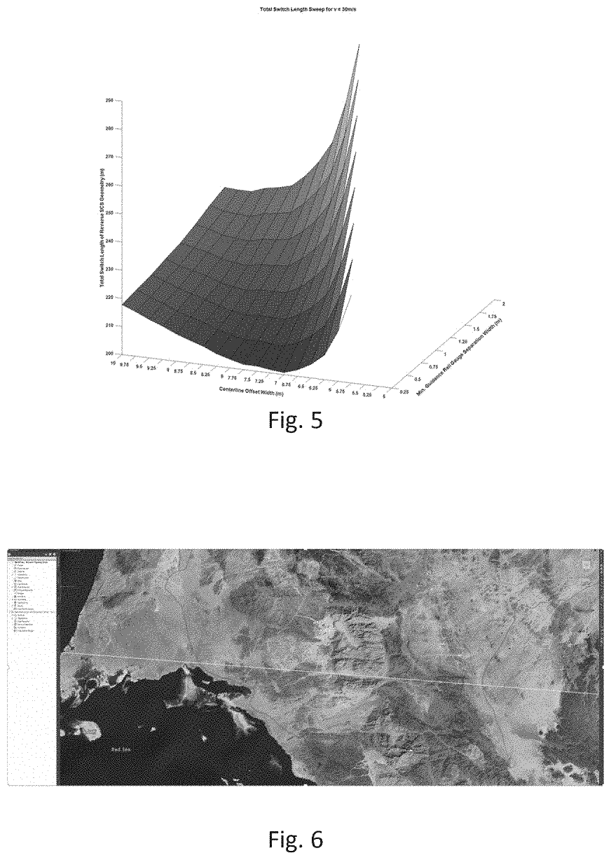

As transportation vehicles are transported, driven or conveyed over a transportation guideway, such as a ground based or suspended rail or a roadway surface, various switches can be placed along the guideway to provide change course/direction of the vehicle. The HSS sweeper provides an analytical/numerical approach to creating reverse spiral-curve-spiral geometry to determine the length of S-curve needed for a moving vehicle to make a change of course, such as a turn, without passengers experiencing excessive lateral or rotational forces due to the acceleration through the switch. FIG. 5 shows an exemplary graph of the HSS sweeper for a total switch length sweep for in which the X-axis is centerline offset width in meters, the Y-axis is total switch length of reverse spiral-curve-spiral geometry in meters, and the Z-axis is the minimum guidance rail gauge separation width in meters. From the HSS sweeper, a determination of which configurations are valid can be determined. Moreover, this HSS sweeper can be used to create a switch catalog, which can be used to create an entire network topology, in which all switches are included in geometries of the entire network.

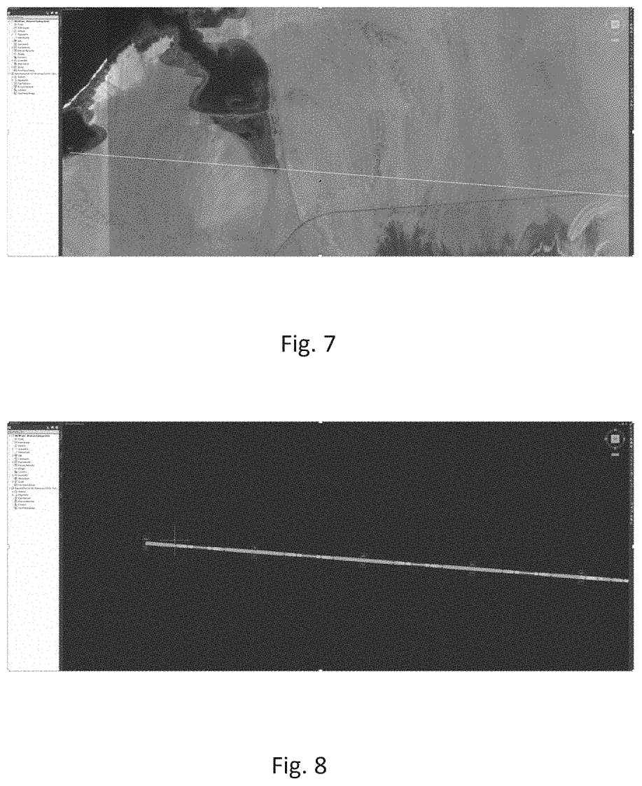

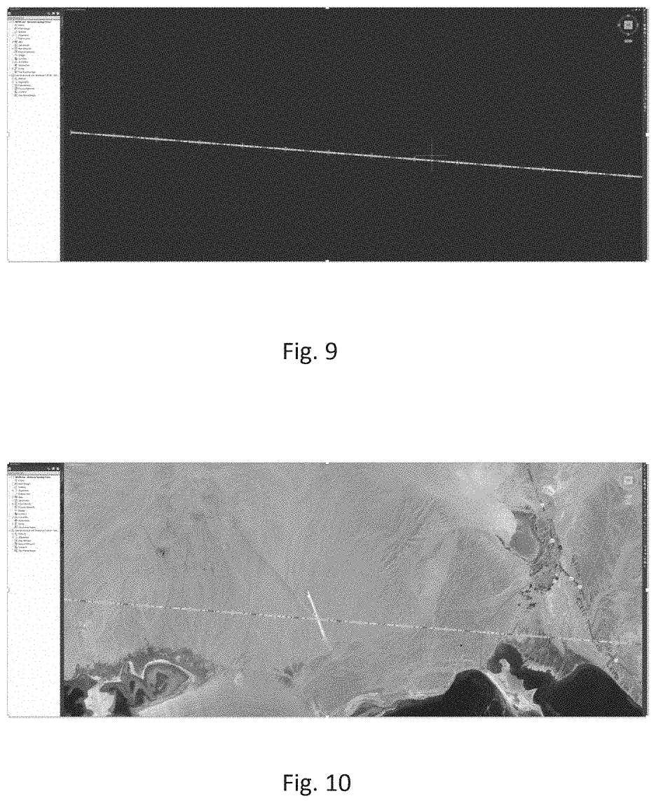

The network topology creator tool can be used to create the entire network geometry connecting multiple origins and destinations, as well as all the switch geometries required to enable point-to-point travel between every origin and destination. The tool can also be used for networks where vehicles point-to-point travel is not required. The tool will create every unique pathway, including the pathway through the reverse spiral-curve-spiral geometry in each switch for any origin-destination pair. Exemplary screenshots of the network topology creator tool are shown in FIGS. 6-10.

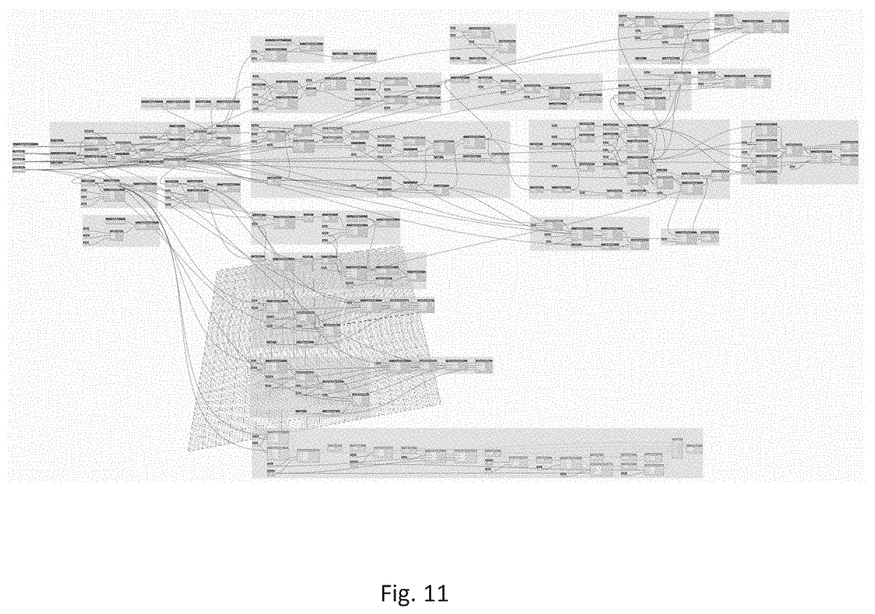

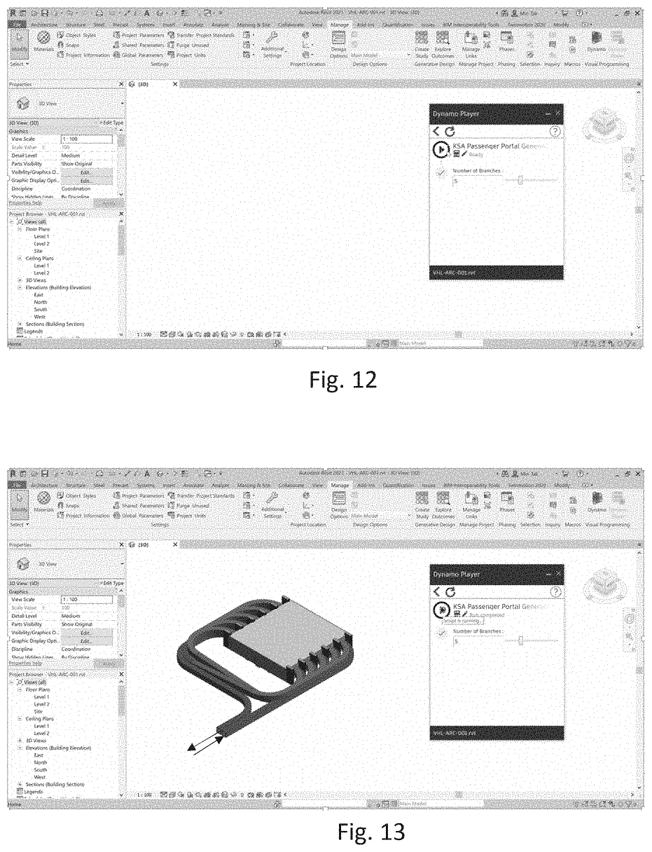

The automation stage can also include a parametric 3D portal creator to produce a portal for passengers to enter and depart from the transportation vehicle. FIG. 11 shows an exemplary network of the visual programming logic behind the tool. FIG. 12 shows a screen shot of the parametric 3D portal creator tool, in which the designer can select from various parameters to generate a 3D design of the portal. Moreover, the tool can generate 3D building elevations. FIG. 13 shows an exemplary 3D representation of a portal created via the tool, in which the portal has one incoming guideway, which is divided into five upper floor and five lower floor arms, and the five upper floor and five lower floor arms are joined into a single outgoing guideway. By way of non-limiting example, the lower floor can be designated for arrivals and departures, while the upper floor can be designated for stabling or storing vehicles not needed in off-peak hours. The upper floor can also support light maintenance activities.

The Digitalization stage is utilized for creating representations of planned or existing conditions and adding digital data. The digitization stage integrates with building information modelling (BIM) frameworks and utilizes a number of unique tools, which are schedule integration, cost integration, portal sustainability tools and digital twin tools. These tools, which can be software, hardware, firmware and combinations thereof, have been developed to facilitate the digitalization stage of the infrastructure lifecycle.

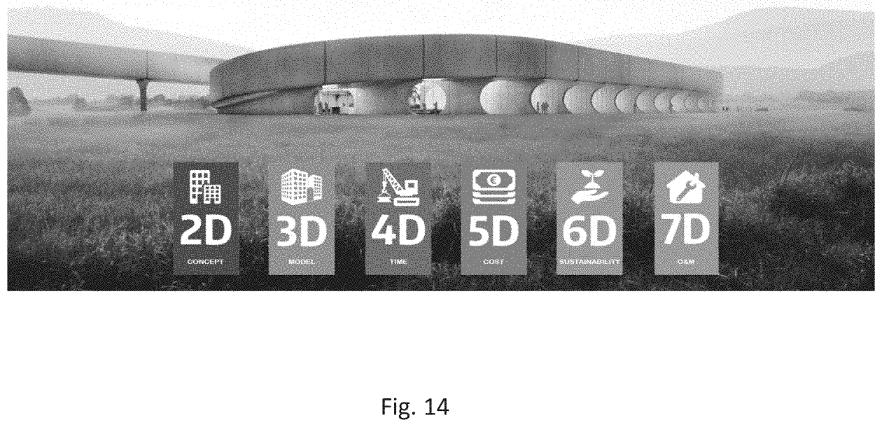

BIM incorporates industry standards for level of detail and inter-disciplinary design model coordination, while providing a modelling framework that enables various types of data to be integrated with it. Typically, a 3-dimensional BIM model is created, and data is integrated with it. Any data integrated with the 3D BIM model is typically considered by the industry in the following vernacular shown in FIG. 14: 4D BIM represents temporal data integration like project schedules, 5D BIM represents cost data, 6D BIM represents sustainability data, and 7D BIM represents operations and maintenance data.

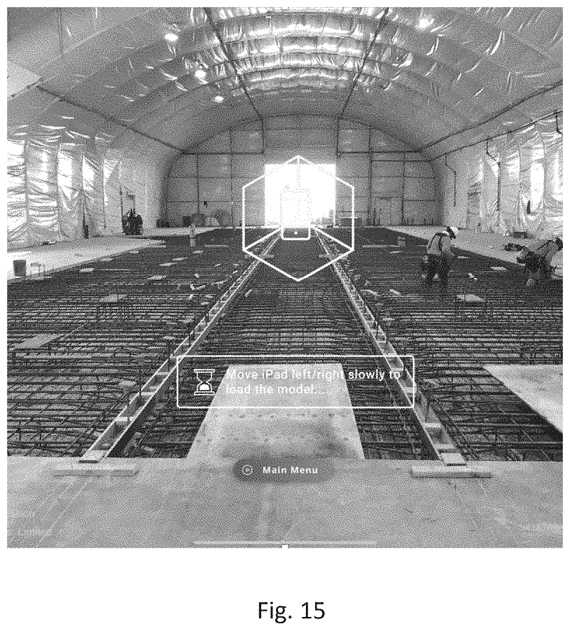

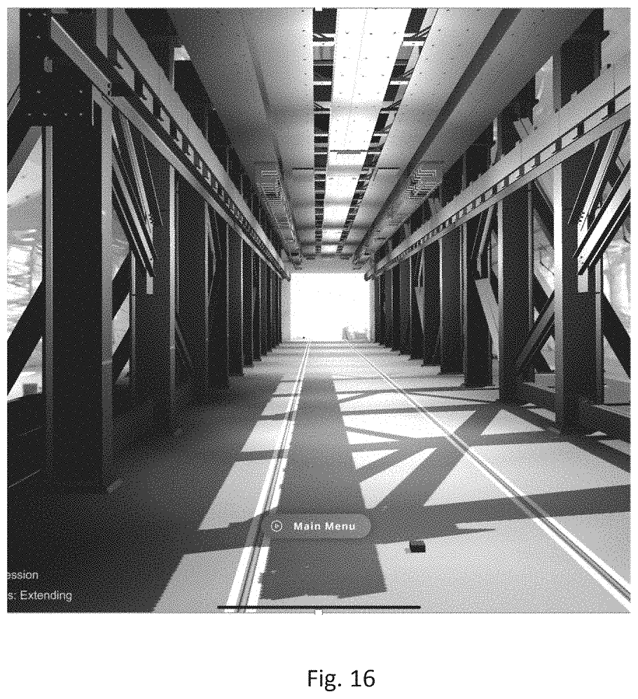

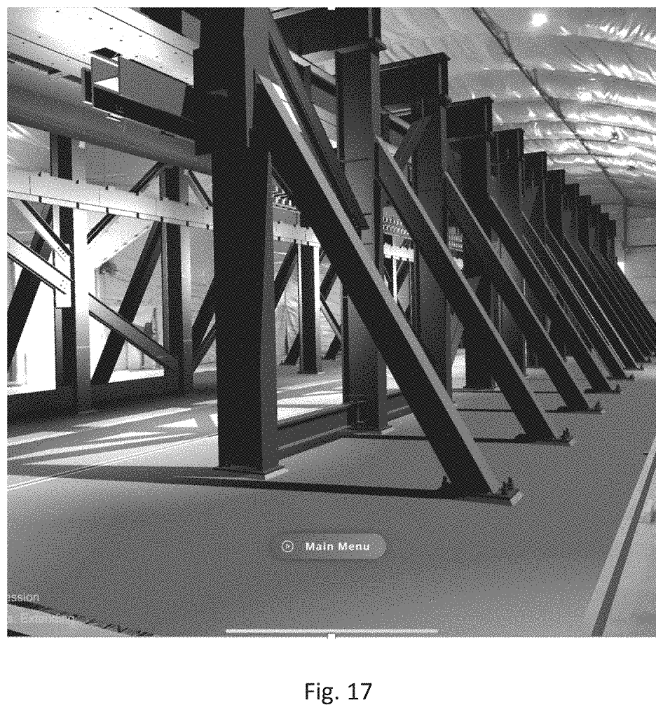

The augment or virtual reality (AR/VR) tools that integrate with the BIM model can show modeled construction, commissioning, operations or maintenance activities on the site at which the user is located. In this regard, using a mobile device, such as a tablet, laptop computer, mobile phone, the user can use a camera incorporated in or coupled to the mobile device to view the area of the surrounding land where the infrastructure activities are desired to take place. Moreover, the AR/VR applications can project to the user the chronological construction of the infrastructure on the site from the ground up. FIGS. 15-17 show exemplary views of AR/VR applications running on a tablet. The user can hold the tablet to view the field in which the infrastructure is to be constructed and the AR/VR application will build up the construction. Moreover, by changing the position and orientation angle of tablet, see, e.g., FIG. 17, details of the infrastructure project at various stages of the project's lifecycle can be viewed. For example, commissioning and operations activities can be animated in an augmented or virtual reality, such as maneuvering a vehicle in single or multiple degrees of freedom, moving or actuating structural components using hydraulics, pneumatics, etc. The user can also interact with maintenance activities, prior to the design and construction of the project, or after the project is already well within its operating phase. The user can be trained interactively with maintenance procedures, such as changing a valve, replacing components, diagnosing equipment, etc., all within an augmented or virtual reality.

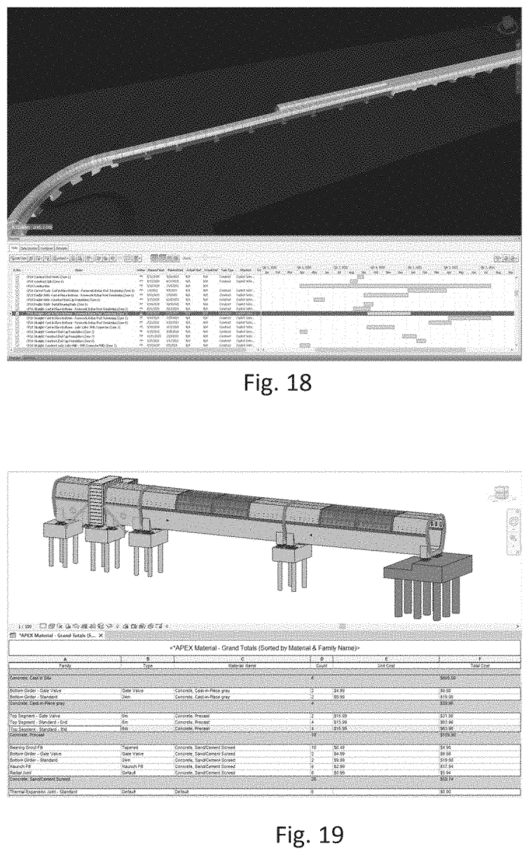

The schedule integration tool can be used to incorporate temporal data into the BIM model, which can be used for determining construction sequencing of the infrastructure project. FIG. 18 shows an exemplary screen shot of the schedule integration tool, in which various construction events are planned in order to complete the infrastructure project. Moreover, the schedule integration tool can also us AR/VR applications to provide high fidelity animations of the construction at a location identified by GPS or LIDAR. For example, in a horizontal infrastructure project, certain activities may take place at different locations along a corridor. The schedule integration tool integrates the temporal activities into the 3D BIM model which uses a real-world coordinate system. When viewing the infrastructure project with the AR/VR tools, the user can be physically present along the corridor, and the tablet's GPS will show the scheduled activities for the project in the vicinity of the user's specific location. LIDAR is used to accurately locate the 3D model in the AR/VR environment, so that, when the user walks along the corridor, the model is updated and does not drift in the tablet.

The cost integration tool can be used with a federated model, which is a 3D BIM model that combines separate models, e.g., earthwork, rebar, pylons, structures, architecture, etc. This tool can be used for determining quantity takeoff, as well as for estimating, budgeting, forecasting and cash flow. FIG. 19 shows an exemplary screen shot of the cost integration tool, which shows various materials, amounts and unit costs for the infrastructure project. The cost integration tool integrates any cost-related data into the 3D BIM model, so that the infrastructure project can be viewed through various cost lenses throughout the project's lifecycle. For example, in early design stages the 3D BIM model will contain estimated cost data, but as the project moves into the delivery stage of its lifecycle, the model will be updated to include cost spent and forecasted expenditures. Later on when the project is in the operating stage of its lifecycle, the cost data will be updated to maintenance costs, replacement costs, operational costs, etc.

The portal sustainability tools can be used to check the infrastructure for compliance with Leadership in Energy and Environmental Design (LEED) certification criteria for portals to be designed and built to be environmentally friendly and energy and resource-efficient standards. Moreover, the horizontal infrastructure is designed for compliance with the ENVISION certification criteria. The portal sustainability tools can also analyze energy performance, daylight analysis/solar studies, lifecycle cost analysis and supply chain sustainability. The portal sustainability tools capture sustainability data and integrate it with the 3D BIM model. The data can be captured for each stage in the project's lifecycle, for example, during the design stage the total embodied carbon can be quantified and integrated with the 3D model, as well as the energy consumption expected during operations, which could vary based on daylight analysis or solar studies. The data can also be captured during construction activities, where large heavy and temporary equipment is used to construct vertical or horizontal infrastructure. Such equipment have their own sustainability impact, such as the direct emissions from diesel-powered generators or equipment. The data can also be captured during the operations and maintenance stages, where the user may want to update their sustainability criteria, or understand the implications of replacing infrastructure components on an unsustainable supply chain with more sustainable alternatives, as the components near their end of life.

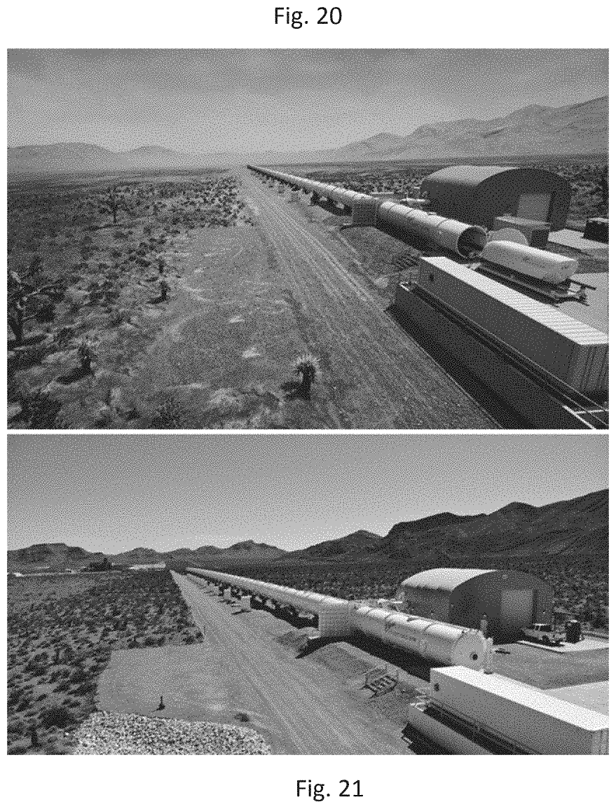

The digital twin tools are part of the O&M stage that are used to produce an essential digital twin of the completed infrastructure project. This tool provides for a convergence between the internet of things and BIM that allows for real-time feed of sensor data, as well as an animated heat maps of the sensor data. FIGS. 20 and 21 respectively show the digital twin view and the real view of the infrastructure project. The digital twin tool also allows for preventative maintenance to be performed from a live feed from the infrastructure, as well as scheduling planned infrastructure maintenance. This tool also allows for asset information on multiple platforms and O&M training in an AR/VR environment. In this regard, the digital twin tools can use the AR/VR environment to instruct operators how to hook up, maintain or update the system. The digital twin tools create a digital representation of the as-built environment, since many infrastructure projects undergo changes throughout construction that are not reflected in the original design models. The digital twin tools allow the infrastructure owner, operator, and/or maintainer to have a 3D model with all informational data layers integrated with it, which includes but is not limited to cost, schedule, sustainability, operations and maintenance data. Hardware sensors enable real-time monitoring of the infrastructure asset. The sensor data is integrated with the digital twin so that it can be represented in a single source of truth 3D model and can inform the owner, operator, and/or maintainer of activities that need to take place in near real-time.

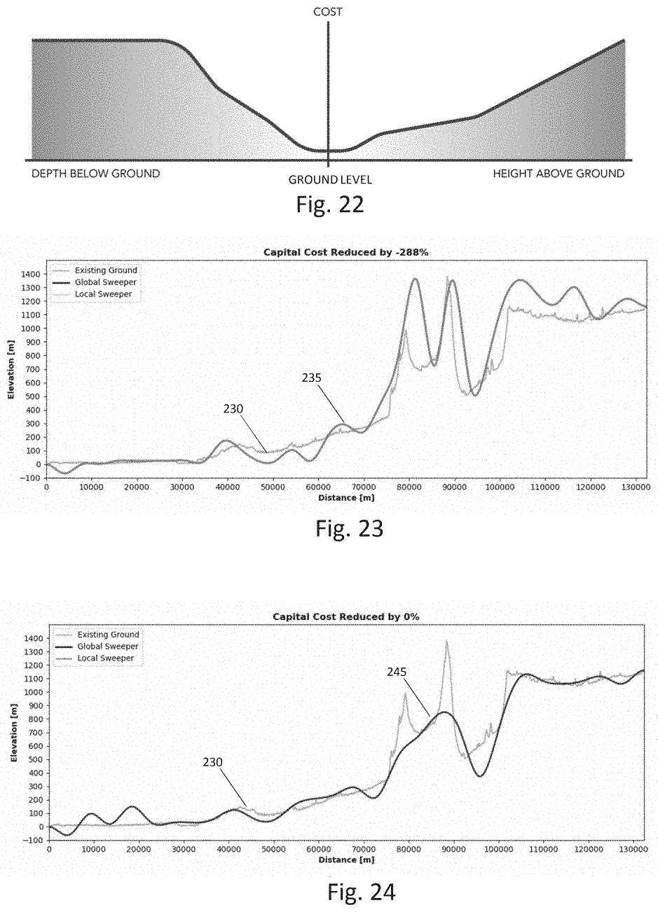

The Optimization stage is utilized for finding solutions that minimize or maximize various objectives, subject to constraints. The tools include the profile optimizer, 3D terrain optimizer, 3D route and trajectory optimizer, 3D network topology optimizer, static portal optimizer and dynamic portal optimizer. These tools, which can be software, hardware, firmware and combinations thereof, have been developed to facilitate the optimization stage of the infrastructure lifecycle. FIG. 22 shows a linear infrastructure cost function in which the center of the graph, labeled “COST” is show that the lowest cost is incurred when the infrastructure is constructed at ground level. The left-hand side of the graph shows that costs increase as construction depth below the ground increases, as this requires the added cost of tunneling, and the right-hand side of the graph shows that costs also increase as construction height above the ground increases, as this requires constructing bridges.

The profile optimizer is a tool that iteratively finds a best course for infrastructure over the geographical profile. FIG. 23 shows an existing ground profile 230 of the terrain over which the infrastructure is to traverse. As can be seen, the ground profile begins as an elevation relative to sea level of 0 meters and gradually rises over a distance of about 77 kilometers to an elevation of about 350 meters. Thereafter, the ground profile rises and falls until it reaches an elevation of about 1,100 meters. In designing a course for the infrastructure, passenger comfort, angle of traverse, vehicle capabilities, vehicle speed and vehicle energy requirements must be considered. An initial optimization iteration 235 for the infrastructure to follow the course of existing ground profile 230 was tested. As can be seen, initial course 235 requires significant tunneling and bridge constructions, which, as previously noted, increases cost. As a result, the capital costs for the infrastructure project using the course from the initial iteration 235 would be increased by 288% when compared with a manually designed course from an independent, third-party engineering expert. The optimizer conducts coarse and fine iterations. The first set of iterations are course and globally set the course of the entire profile, while later iterations are fine and locally adjust the profile in certain regions along the course. The combination of the coarse and fine iterations provide optimal results for a course that is otherwise extremely difficult for an engineer to produce manually, and very unlikely to be as optimal in terms of capital cost.

However, the profile optimizer is iteratively run using alternative course profiles over the existing ground profile until a best course/most economical course is found. By way of example, FIG. 24 shows a second possible course 245 over existing ground profile 230. In this course 185, the amount of bridge construction, with respect to course 245 is reduced, but the amount of tunneling is increased. With this course 245, the capital cost for the infrastructure over the existing ground profile 230 would have been reduced by 0%, which is on target with the project budgeting and much better than the 288% capital cost overrun by the initial iteration's course 235.

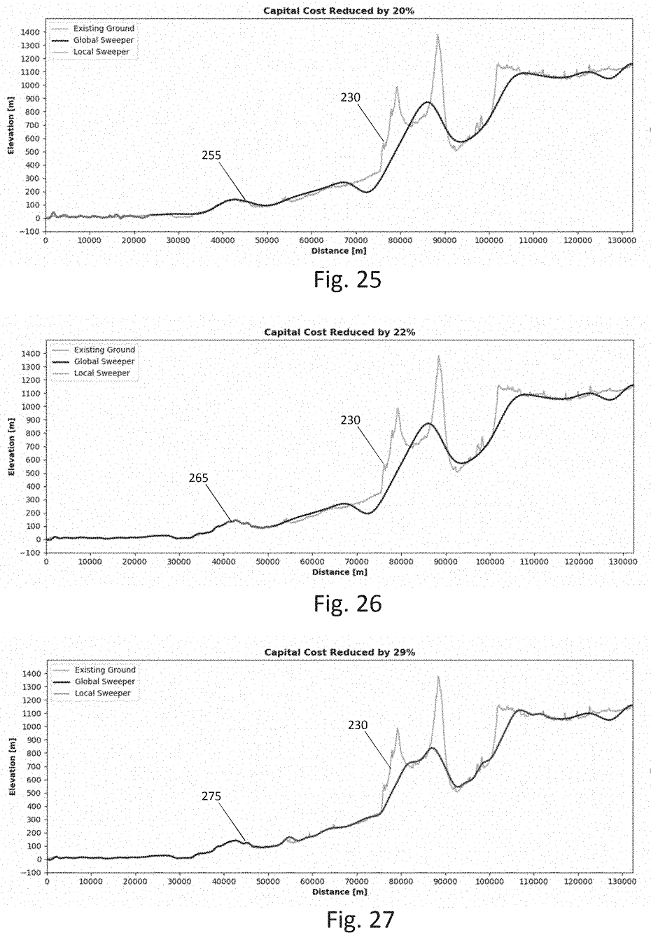

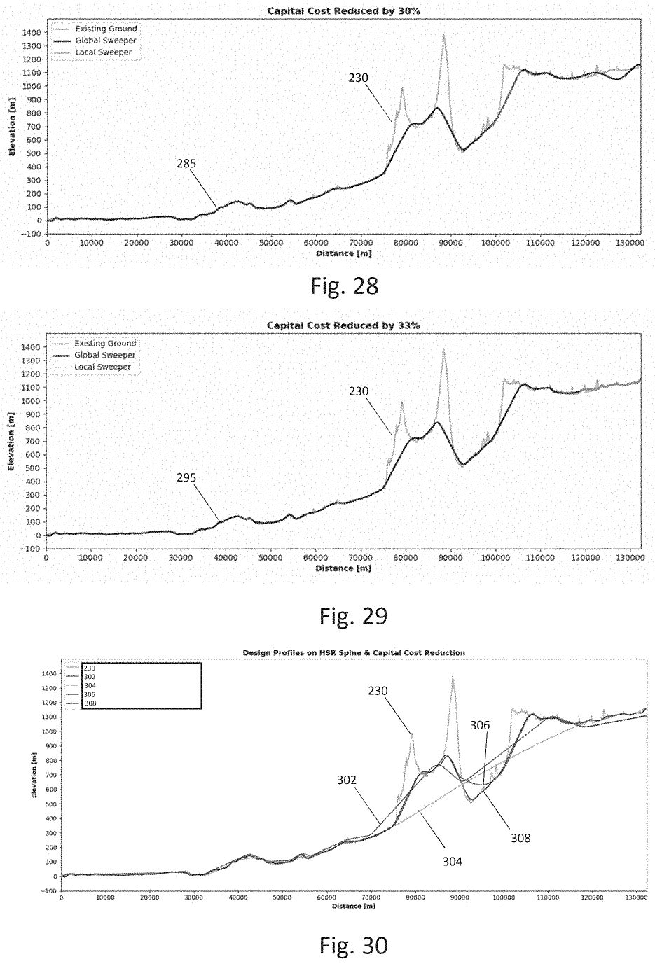

As the profile optimizer iteratively runs alternative course profiles over existing ground profile 230, FIGS. 25-29 show convergence of optimal courses 195-235, in which the capital cost for the infrastructure over existing ground profile 230 is reduced by 20%, 22%, 29%, 30% and 33%, respectively. However, it is understood that the profile optimizer may iteratively run thousands of alternative courses in finding the best course for the infrastructure project.

FIG. 30 shows a comparative example of various courses 302-308 over existing ground profile 230. Course 302 is a real-world infrastructure design made in accordance with the known project lifecycle process from an independent, third-party expert. Course 304 is an optimization of a competitor mode of transportation over the existing ground profile 230, which provides a 12% reduction in capital costs in relation to course 302. Course 306 is an optimization of course 302 using the iterative process of the profile optimizer. Course 306 provides a 23% reduction in capital costs in relation to course 302. Course 308 is the result of the iterative process of the profile optimizer based on the existing ground profile 230. Course 308 provides a 33% reduction in capital costs in relation to course 308. Courses 304 and 306 are optimized using the profile optimizer with vehicle capability constraints from the competitor's mode of transportation, which is unable to climb steeper gradients than the mode used for course 308.

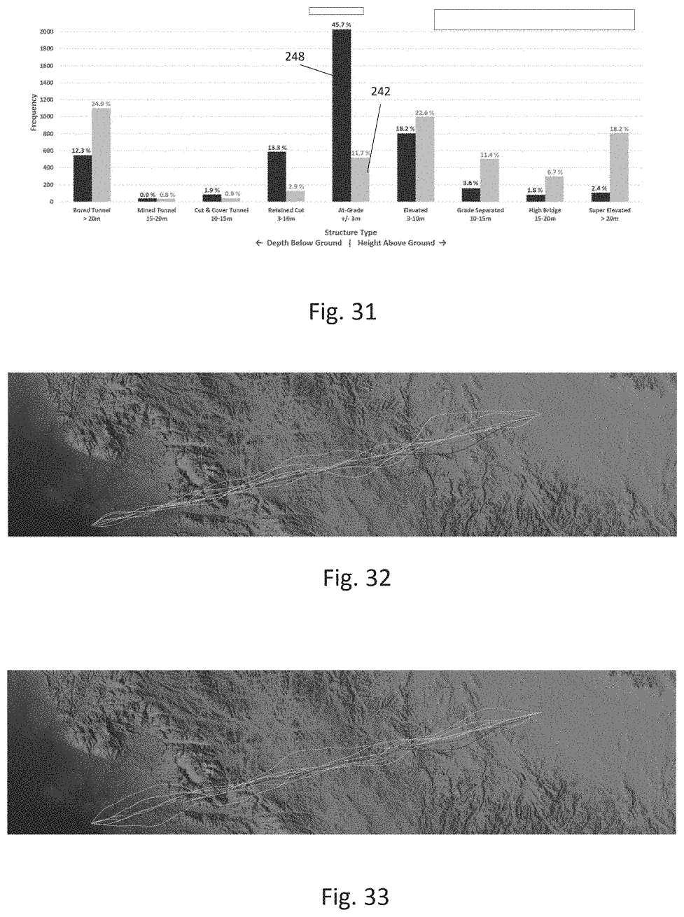

FIG. 31 shows a histogram of the profile optimized infrastructure of course 308 versus course 302, as shown in FIG. 30. The left-hand sides of the bar graphs correspond to course 308 and the right-hand sides of the bar graphs correspond to course 302. From this histogram, it is readily apparent that course 308 produced by the iterative process results in a course that is 45.7% constructed at ground level, while course 302 is only 11.7% constructed at ground level. Moreover, it is readily apparent that, as the structure type moves away from “at grade,” i.e., in the middle of the histogram (left side depth below ground; right side height above ground), the percentage of the construction of course 302 significantly exceeds the percentage of construction of course 308. In fact, as noted in FIG. 30, the capital costs for course 308 are 33% lower as compared to those of course 302.

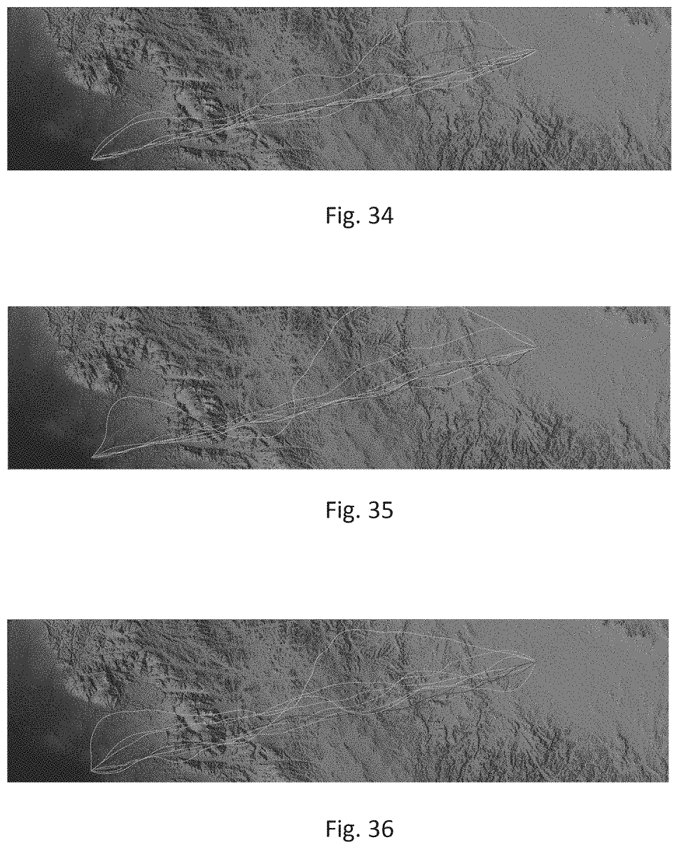

The 3D terrain optimizer, like the profile optimizer, utilizes an iterative process to minimize capital costs of the linear infrastructure, i.e., the optimization is based on the terrain over which the linear infrastructure may be constructed, but not on bridges or bodies of water. Moreover, the 3D terrain optimizer is constrained by considerations such as passenger comfort and vehicle capability. FIGS. 32-36 show the iterative process analyzing the capital costs over various paths traversing the terrain. The different lines/paths represent different 3D courses that satisfy vehicle capability and passenger comfort with near optimal capital costs.

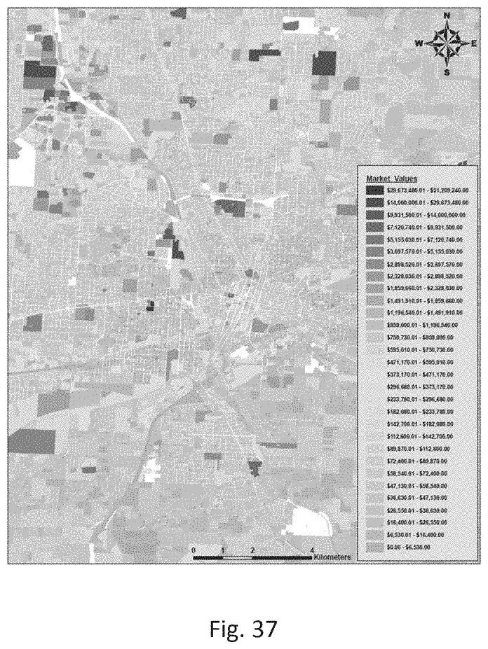

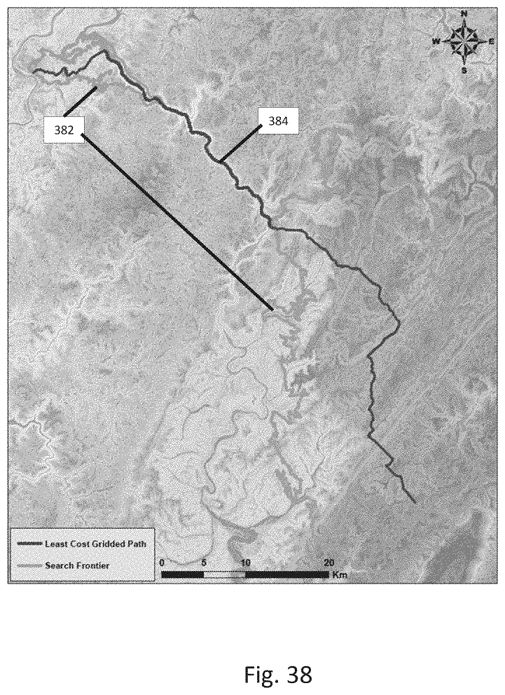

Moreover, in order to be able to incorporate land cost into capital cost optimizations, the 3D route and trajectory optimizer and the network topology optimizer can access geographic information system (GIS) data stores to achieve multi-objective optimization. By way of non-limiting example, can aggregate optimizations for environmental impact, land use, travel time, energy, passenger comfort, operations, maintenance, and reliability. For example, FIG. 37 shows a map of an area of interest for infrastructure construction, in which the market values of the various parcels of land are color coded. Using this information, further optimization can be obtained by additionally utilizing terrain data in order to ascertain a best course over the area of interest. FIG. 38 shows an exemplary map of an area of interest over which linear infrastructure is to be constructed. The map can include search areas 382 that are optimized to obtain a least cost path 384 for the desired linear infrastructure. Further, the optimization can include machine learning features for cost function weights, imputation of missing GIS data, and GIS data classification. The network topology optimizer utilizes the 3D route and trajectory optimizer for multiple city-pairs or origin-destination nodes. The network topology optimizer also includes transportation GIS data for determining the ideal locations of stations within cities or regions, as well as the optimal 3D course connecting each station, city or region.

The layout of a portal or station can be optimized via the portal optimization tool. This portal optimization tool can include static optimization and dynamic optimization. Static optimization of the portal layout can be used to fit site-specific constraints and can be based, e.g., on peak demand in the portal or station. Dynamic optimization of portal layout can be based on asymmetric and temporal demand, e.g., based on changing demand. Further, 3D geometric representations of the station can be generated.

The Simulation stage is utilized for creating representations of, e.g., run-time operations of vehicles travelling over the guideway or step-wise construction of the infrastructure. The simulation stage utilizes a number of unique tools, which include a dynamic clash detection, construction sequence simulation, passenger and portal operations simulation, and Monte Carlo cost simulation. These tools, which can be software, hardware, firmware and combinations thereof, have been developed to facilitate the digitalization stage of the infrastructure lifecycle.

Clash detection can be used to simulate any clash or conflict between the models utilized in an infrastructure design, which can be understood to be a static clash detection, or to simulate operation of vehicle traveling over the guideway, which can be understood to be dynamic clash detection. This dynamic clash detection can simulate the effects on the vehicle, while varying various parameters, e.g., air gap, ride height and speed, as the vehicle travels over tunnels, hills and bridges at various design speeds in nominal and off-nominal conditions.

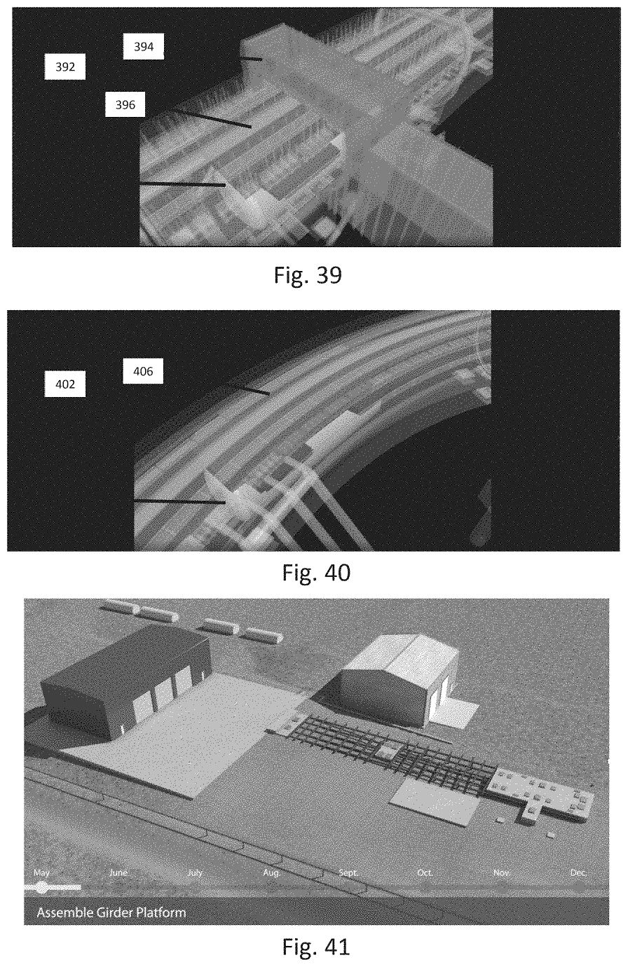

FIG. 39 shows a dynamic simulation of the vehicle 392 passing through a gate valve 394, where an error clash 396 is detected in the simulation, which allows the designer to make revisions to this region of the infrastructure to avoid this clash in the constructed system. FIG. 40 shows a dynamic simulation of vehicle 402 guided around a tight radius turn, where an error clash 406 is detected in the simulation, which allows the designer to make revisions to this region of the infrastructure to avoid this clash in the constructed system. Moreover, dynamic simulation can be performed on the vehicle as it passes through switches or switching points to look for a clashes when passing through a switch, when changing course in the switch, when multiple guideways are merging into a single guideway, and based on the results, allows the designer to make revisions to avoid any switch clashes in the constructed system. In a typical transportation infrastructure project, these clashes would be realized during the commissioning stage of the project's lifecycle, which could result in significant design changes and construction activities taking place to remedy the clash, ultimately leading to cost overruns.

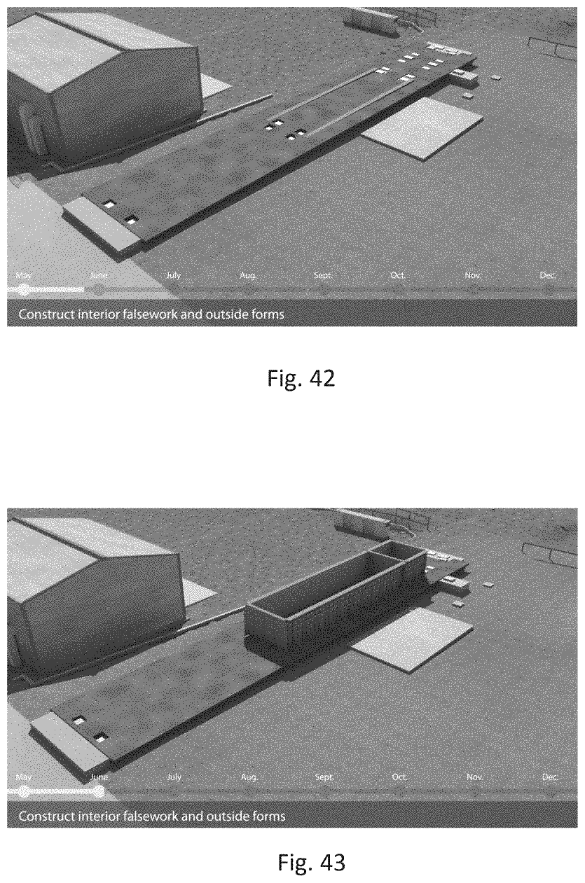

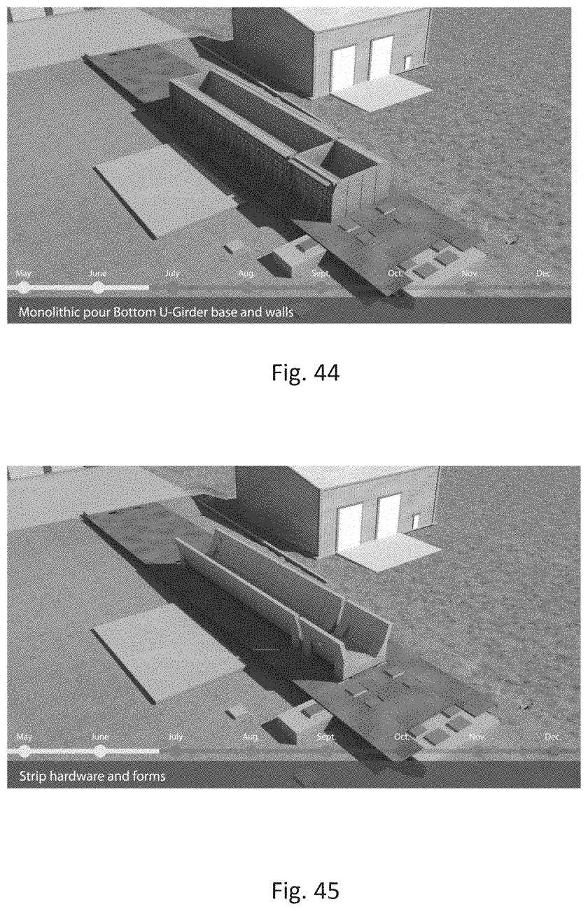

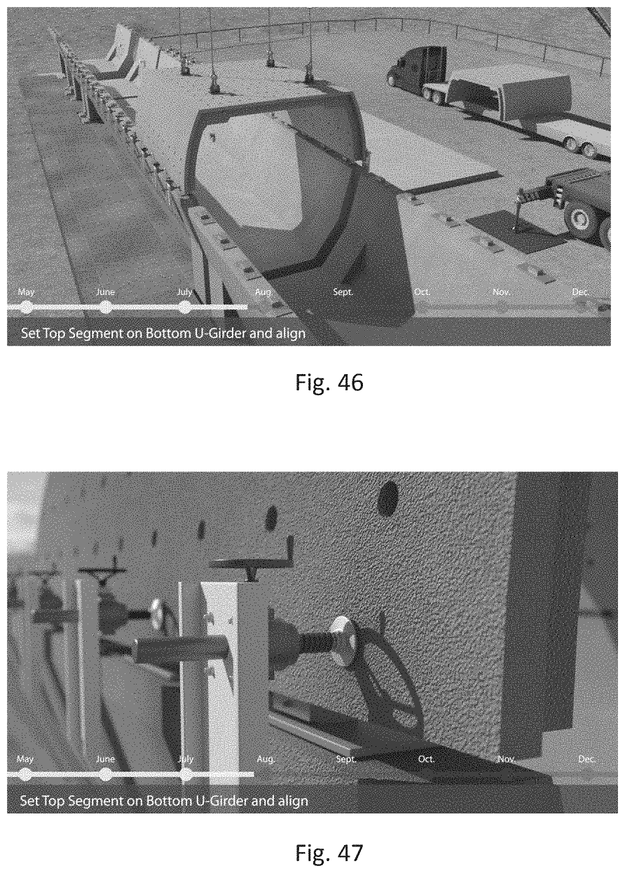

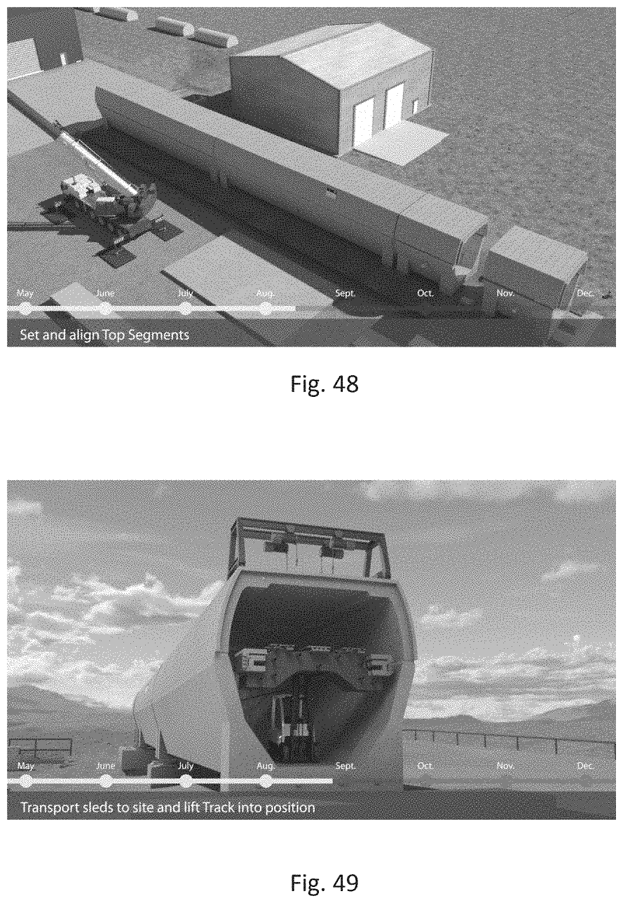

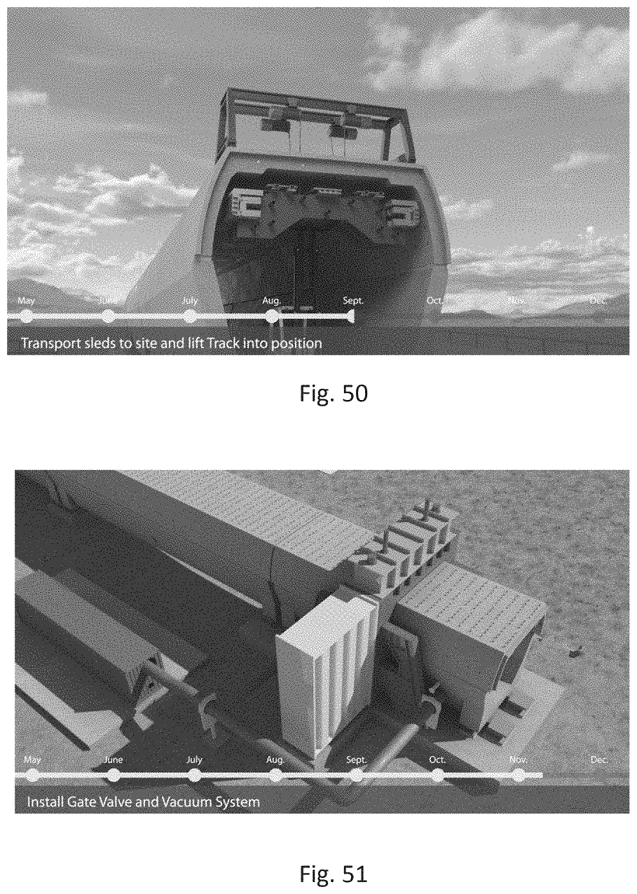

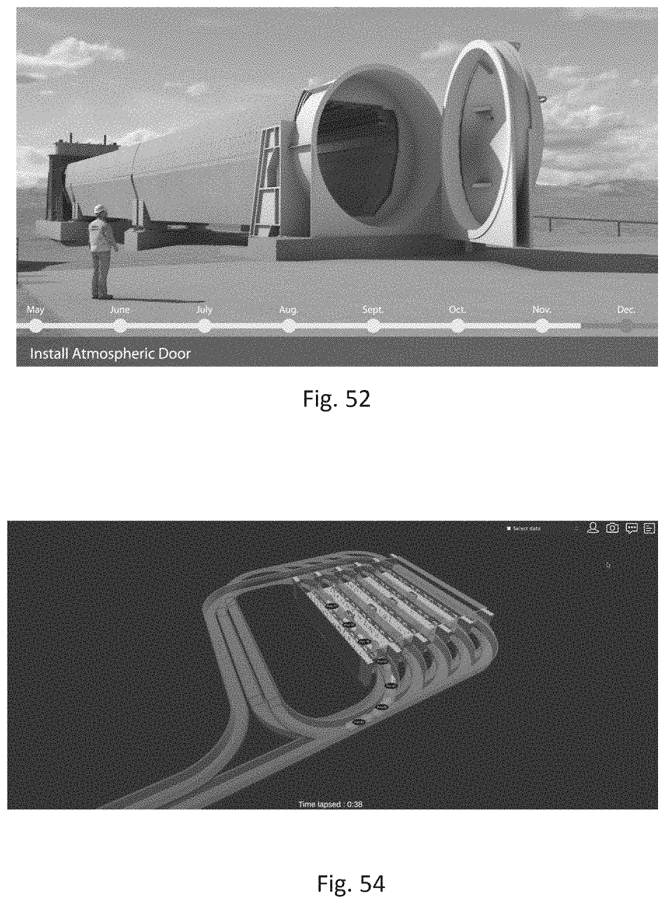

Construction sequence simulation utilizes digitalization and the 3D models to show the building of the portal and/or guideway from the ground (or below the ground) up. FIGS. 41-52 show a simulation of the construction process, which begins with the assembly of a girder platform (FIG. 41) and then with the construction of interior falsework and outside forms (FIG. 42) and additional outside forms (FIG. 43). The process can then pour a bottom U-girder base and walls using the outside forms (FIG. 44) and then the hardware and forms can be stripped away (FIG. 45). The simulation can continue to show the top segment being set on and precisely aligned with the bottom U-girder (FIG. 46) using, e.g., the tools depicted in FIG. 47, and then proceeds with the setting and aligning of further top segments (FIG. 48). The simulation can further show transport sleds being positioned at the site and lifting track pieces into position (FIGS. 49 and 50). FIG. 51 shows an exemplary simulation of the installation of gate valves and the vacuum system and FIG. 52 shows the simulation of the installation of an atmospheric door.

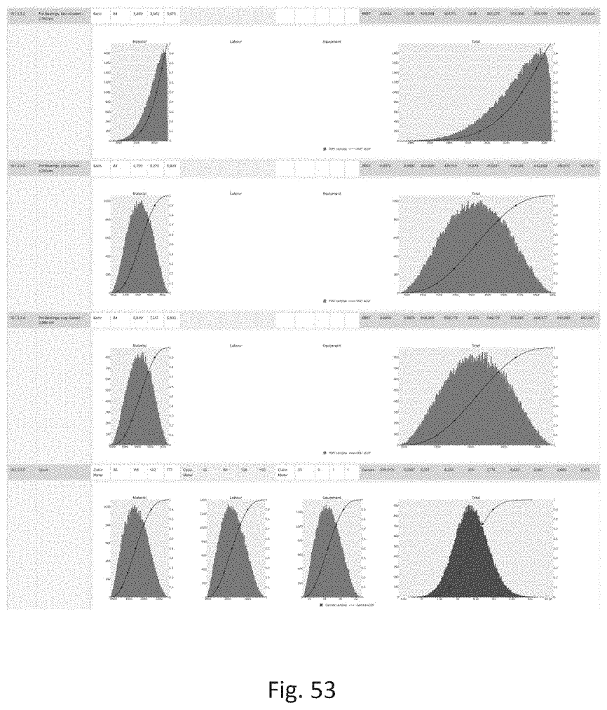

Additional simulation can be performed to quantify cost risk and uncertainty at every level of infrastructure, as shown in FIG. 53. By way of example, these simulations can be performed by capturing material, equipment and labor cost breakdowns and simulating the building of the infrastructure thousands of time with adjustments to material, equipment and labor costs. Typically, infrastructure project costs are estimated early on using top-down approaches with historical data and public guidelines. Such methods do not accurately estimate cost, risk, or uncertainty; and therefore, leads to significant cost overruns as the project continues beyond the development stage in its lifecycle. The Monte Carlo Cost Simulation tool uses a bottom-up approach by starting with the quantities in a fully federated, single source of truth BIM model of the infrastructure. Infrastructure components are broken down into a product hierarchy, e.g., the substructure could contain elements such as piles, pile caps, piers, pier caps, and bearings. Each element is broken down to its most elementary level and its material is quantified, along with the labor and equipment required to construct the element. Three costs are estimated for each element: the absolute minimum, the most common estimate, the absolute maximum. Cost distributions are created for each element's material, equipment and labor breakdown, and convolved into a total distribution for the element. The elements total distributions are further convolved up the hierarchical chain of infrastructure components, until the total infrastructure cost distribution is formed. This tool allows the user to quantify the cost uncertainty and risk associated with any element or any group of elements and allows the user to budget against quantified uncertainty and risk. This tool can be used for any infrastructure project, as well as any type of product, e.g., software, vehicles, rockets, etc.

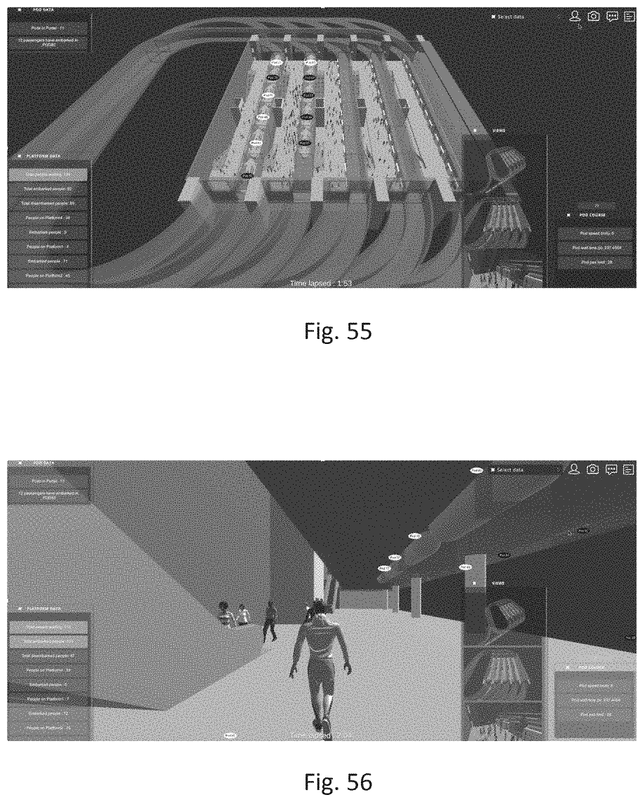

Passenger and portal operations simulations can be used to simulate operations and maintenance (O&M) of stations or airports. FIG. 54 shows a simulation of a portal in which a number of vehicles are approaching the portal or are already in arrival lanes. FIG. 55 shows a more detailed simulation of the arrival lanes and also simulates the movement of people departing from the vehicles. FIG. 56 shows a more detailed simulation of passengers traversing the general walkways and escalators in the portal. These simulations can be dynamic in that the simulations can be varied based upon estimated passenger loads at various times. The passenger movement in the portal is simulated to mimic real stochastic passenger behavior. The number of passengers appearing in the simulation is based on an estimated demand for an on-demand system, e.g., similar to ridesharing applications where users can request a trip and no scheduled service exists. The vehicles in the simulation are responding to passenger demand and are arriving at the given portal within a reasonably immediate time window from the passenger's booking. The passengers are directed to their vehicle which is travelling direct to the passenger's destination, with no stopping in between.

System Environment

Aspects of embodiments of the present disclosure (e.g., control systems for the augmented permanent magnet system) can be implemented by such special purpose hardware-based systems that perform the specified functions or acts, or combinations of special purpose hardware and computer instructions and/or software, as described above. The control systems may be implemented and executed from either a server, in a client server relationship, or they may run on a user workstation with operative information conveyed to the user workstation. In an embodiment, the software elements include firmware, resident software, microcode, etc.

As will be appreciated by one skilled in the art, aspects of the present disclosure may be embodied as a system, a method or a computer program product. Accordingly, aspects of embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure (e.g., control systems) may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, a magnetic storage device, a USB key, and/or a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present disclosure may be embodied in a field programmable gate array (FPGA).

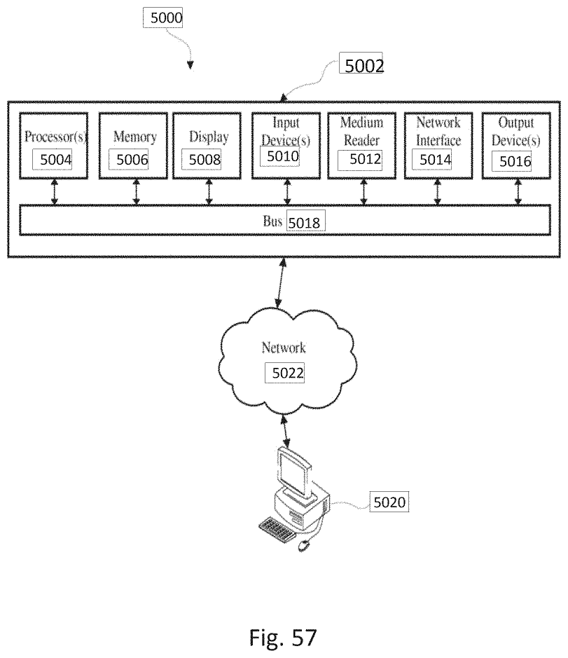

FIG. 57 is an exemplary system for use in accordance with the embodiments described herein. The system 5700 is generally shown and may include a computer system 5702, which is generally indicated. The computer system 5702 may operate as a standalone device or may be connected to other systems or peripheral devices. For example, the computer system 5702 may include, or be included within, any one or more computers, servers, systems, communication networks or cloud environment.

The computer system 5702 may operate in the capacity of a server in a network environment, or in the capacity of a client user computer in the network environment. The computer system 5702, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 3902 is illustrated, additional embodiments may include any collection of systems or sub-systems that individually or jointly execute instructions or perform functions.

As illustrated in FIG. 57, the computer system 5702 may include at least one processor 5704, such as, for example, a central processing unit, a graphics processing unit, or both. The computer system 5702 may also include a computer memory 5706. The computer memory 5706 may include a static memory, a dynamic memory, or both. The computer memory 5706 may additionally or alternatively include a hard disk, random access memory, a cache, or any combination thereof. Of course, those skilled in the art appreciate that the computer memory 5706 may comprise any combination of known memories or a single storage.

As shown in FIG. 57, the computer system 5702 may include a computer display 5708, such as a liquid crystal display, an organic light emitting diode, a flat panel display, a solid state display, a cathode ray tube, a plasma display, or any other known display. The computer system 5702 may include at least one computer input device 5710, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 5702 may include multiple input devices 5710. Moreover, those skilled in the art further appreciate that the above-listed, exemplary input devices 5710 are not meant to be exhaustive and that the computer system 5702 may include any additional, or alternative, input devices 5710.

The computer system 5702 may also include a medium reader 5712 and a network interface 5714. Furthermore, the computer system 5702 may include any additional devices, components, parts, peripherals, hardware, software or any combination thereof which are commonly known and understood as being included with or within a computer system, such as, but not limited to, an output device 5716. The output device 5716 may be, but is not limited to, a speaker, an audio out, a video out, a remote control output, or any combination thereof.

Furthermore, the aspects of the disclosure may take the form of a computer program product accessible from a computer-usable or computer-readable medium providing program code for use by or in connection with a computer or any instruction execution system. The software and/or computer program product can be implemented in the environment of FIG. 57. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

It is to be understood that the above-described process is merely exemplary and should not be construed as limiting the process to performance in any particular order.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the disclosure are not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk, tapes or other storage device to capture carrier wave signals such as a signal communicated over a transmission medium. Accordingly, the disclosure is considered to include any computer-readable medium or other equivalents and successor media, in which data or instructions may be stored.

While the specification describes particular embodiments of the present disclosure, those of ordinary skill can devise variations of the present disclosure without departing from the inventive concept.

One or more embodiments of the disclosure may be referred to herein, individually and/or collectively, by the term “invention” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the disclosure has been described with reference to specific embodiments, those skilled in the art will understand that various changes may be made and equivalents may be substituted for elements thereof without departing from the true spirit and scope of the disclosure. While exemplary embodiments are described above, it is not intended that these embodiments describe all possible forms of the embodiments of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiments may be combined to form further embodiments of the disclosure.

While the specification describes particular embodiments of the present disclosure, those of ordinary skill can devise variations of the present disclosure without departing from the inventive concept.

Insofar as the description above and the accompanying drawing disclose any additional subject matter that is not within the scope of the claims below, the embodiments are not dedicated to the public and the right to file one or more applications to claim such additional embodiments is reserved.

What is claimed:

1. A system for design and implementation of a project comprising:
a plurality of design and testing tools directed to phases of the project's lifecycle,
wherein the plurality of design and testing tools is usable for physical horizontal and vertical infrastructure,
wherein the physical and vertical infrastructure of the project is constructed based upon a project design created and tested from the plurality of design and testing tools.

2. The system according to claim 1, wherein the project includes at least one of roads, rail, pipelines, powerlines, stations, airports, facilities, utilities, hyperloop.

3. The system according to claim 1, wherein the plurality of design and testing tools comprises automation tools for monitoring and analyzing topological surface elevations on land and under water for potential locations for construction of the project, and for determining a length of a curve for vehicles to accelerate through a turn at a switch without passengers experiencing excessive lateral or rotational forces.

4. The system according to claim 3, wherein the automation tool includes a network topology creator tool that creates an entire network geometry connecting multiple origins and destination, and includes switch geometries for point-to-point travel between each of the multiple origins and the destination.

5. The system according to claim 3, wherein the automation tool includes a 3D portal creator to design and produce a passenger portal for passengers of a vehicle to embark and disembark the vehicle and for storage and maintenance of the vehicles.

6. The system according to claim 1, wherein the plurality of design and testing tools comprises digitalization tools for creating representations of planned or existing conditions.

7. The system according to claim 6, wherein the digitalization tools incorporate building information modeling (BIM) framework with at least one of schedule integration, cost integration, portal sustainability and digital twin tools.

8. The system according to claim 7, wherein the BIM framework is integrated with augmented or virtual reality (AR/VR) tools to show modeled construction, commissioning, operations or maintenance activities at a particular site.

9. The system according to claim 8, wherein, for construction, the AR/VR tools can project to a user a chronological construction from the ground up of the project over a view of the site where the user is located,
wherein, for commissioning and operations, the AR/VR tools can show animations of a maneuvering of a vehicle in at least one degree of freedom or moving or actuating of structural elements.

10. The system according to claim 7, wherein the digitalization tool further includes at least one of a schedule integration tool that incorporates temporal data into the BIM framework to determine construction sequencing of the project, a cost integration tool for determining quantity takeoff, estimating, budgeting, forecasting and cash flow, or a portal sustainability tool to check the infrastructure of compliance with certification criteria to be environmentally friendly and energy and resource efficient.

11. The system according to claim 1, wherein the plurality of design and testing tools comprises optimization tools for finding solutions to minimize or maximize various objectives, subject to constraints.

12. The system according to claim 11, wherein the optimization tools includes a profile optimizer that iteratively examines different courses for the infrastructure over the geographic profile to find a best course.

13. The system according to claim 12, wherein the different courses are designed for passenger comfort, angle of traverse, vehicle capabilities, vehicle speed and vehicle energy requirements.

14. The system according to claim 11, wherein the optimization tool includes a 3D terrain optimizer that is an iterative process over multiple geospatial datasets, such as but not limited to terrain, land use, environmentally sensitive areas, parcel cost, etc. to minimize various objectives such as but not limited to capital costs, travel times, energy consumption, environmental impact or maximize various objectives such as but not limited to passenger comfort, energy efficiency, etc. of the project based on various courses over multiple geospatial data layers where the project is to be constructed.

15. The system according to claim 1, the plurality of design and testing tools comprises simulation tools for creating at least one of representations of run-time operations of vehicles over a guideway of the project or step-wise construction of the project.

16. The system according to claim 15, wherein the simulation tools comprise at least one of dynamic clash detection, construction sequence simulation, or passenger and portal operations simulation.

17. The system according to claim 16, wherein the dynamic clash detection is at least one of operable to simulate a clash between models used in the project design or to simulate operation of a vehicle traveling over a guideway of the project.

18. The system according to claim 16, wherein the construction sequence simulation is operable to show a building of the project from ground up.

19. The system according to claim 16, wherein the simulation tools include simulations for quantifying cost risk and uncertainty at every level of the project.

20. A smart infrastructure system for design and implementation of a project comprising:
a processor;
at least one memory containing instructions that, when executed by the processor, cause the processor to perform operations including:
at least one of monitoring and analyzing topological surface elevations on land and under water for at least one of potential locations for construction of the project, or for determining a length of a curve for vehicles to accelerate through a turn at a switch without passengers experiencing excessive lateral or rotational forces;
using AR/VR tools to at least one of project to a user a chronological construction from the ground up of the project over a view of the site where the user is located, or show animations of a maneuvering of a vehicle in at least one degree of freedom or moving or actuating of structural elements;
at least one of determining construction sequencing of the project, determining quantity takeoff and estimating, budgeting, forecasting and cash flow, or checking the infrastructure of compliance with certification criteria to be environmentally friendly and energy and resource efficient; and
simulating at least one of a clash between models used in the project design or operation of a vehicle traveling over a guideway of the project.
